(19) United States
(12) Patent Application Publication
(10) Pub. No.: US 2014/0330506 A1
(43) Pub. Date: Nov. 6, 2014

(54) HUMAN MACHINE INTERFACE FOR REAL TIME TRIP COMPARISON

(71) Applicants: VOLKSWAGEN AKTIENGESELLSCHAFT, WOLFSBURG (DE); AUDI AG, INGOLSTADT (DE)

(72) Inventors: Brian NG, San Francisco, CA (US); Anna Korina LOUMIDI, Belmont, CA (US); Filip CHUDZINSKI, Berlin (DE); Hendrik FRANK, Braunschweig (DE)

(73) Assignees: VOLKSWAGEN AKTIENGESELLSCHAFT, WOLFSBURG (DE); AUDI AG, INGOLSTADT (DE)

(21) Appl. No.: 14/264,779

(22) Filed: Apr. 29, 2014

Related U.S. Application Data
(60) Provisional application No. 61/818,523, filed on May 2, 2013.
(60) Provisional application No. 61/826,160, filed on May 22, 2013.

(51) Int. Cl. G07C 5/08

(52) U.S. Cl. CPC G07C 5/085
USPC 701/123; 701/29.1; 701/32.5

(57) ABSTRACT

A method and system for comparing vehicle trip data of a current vehicle trip to historical vehicle trip data in real time includes recording vehicle trip data and creating a record of historical vehicle trip data and during the current vehicle trip, evaluating the current vehicle trip. The record of historical vehicle trip data includes vehicle trip data from at least one previously conducted vehicle trip. The evaluating includes recording vehicle data during the current vehicle trip, accessing the record of historical vehicle trip data, and comparing the vehicle trip data of the current vehicle trip to the historical vehicle trip data in real time during the current vehicle trip.

This nonprovisional application claims priority to U.S. Provisional Application No. 61/818,523, which was filed on May 2, 2013 and to 61/826,160, which was filed on May 22, 2013, and which are both herein incorporated by reference.

### BACKGROUND OF THE INVENTION

1. Field of the Invention

The present invention relates to vehicle onboard diagnostic systems and more particularly to a method and system for comparing vehicle trip data to saved vehicle trip data in real-time.

2. Description of the Background Art

Current vehicle systems are designed to provide increasing amounts of vehicle-related information to their users. Additionally, there is growing desire for vehicle owners to understand the performance of their vehicles, especially related to vehicle fuel consumption. Also, vehicle operators, especially commuters, desire to determine the shortest (i.e., duration and/or time) possible vehicle route to a destination. Certain conventional systems have been designed in which the system presents current trip data (e.g., distance, duration and average fuel consumption) as well as static data of a saved trip.

For example, U.S. Pat. No. 7,599,770 discloses a system that tracks and logs distance traveled by a vehicle during a trip. The system can display the trip information to the user and allows the user to output the travel information to another device.

The existing systems do not, however, offer a real-time comparison of the current trip to a saved trip, in order to compare vehicle trip data while driving.

Furthermore, other embedded or aftermarket solutions offer real-time feedback to the customer while driving. This feedback, however, is based on a comparison of the current driving data to some fixed “standard” data. The conventional systems do not allow for a comparison to data of a saved trip that the customer has driven. Furthermore, the conventional systems focus on training the customer on driving more energy efficient and improving their driving skills towards this goal.

### SUMMARY OF THE INVENTION

In view of the foregoing and other exemplary problems, drawbacks, and disadvantages of the conventional methods and structures, an exemplary feature of the present invention is to provide a method and system for comparing a current vehicle trip to previously conducted vehicle trips during the current vehicle trip.

According to a first non-limiting, exemplary aspect of the invention, a method includes accessing a record of a previous conducted vehicle trip, the record comprising vehicle trip information for the previous conducted vehicle trip, recording vehicle information for a current vehicle trip, and comparing the vehicle information for the current vehicle trip to the vehicle trip information for the previous conducted vehicle trip.

According to a second non-limiting, exemplary aspect of the invention, a system includes a database containing a record of a previous conducted vehicle trip, the record comprising vehicle trip information for the previous conducted vehicle trip, a record device configured to record vehicle information for a current vehicle trip, and a component configured to compare the vehicle information for the current vehicle trip to the vehicle trip information for the previous conducted vehicle trip.

According to a third non-limiting, exemplary aspect of the invention, a method for comparing vehicle trip data of a current vehicle trip to historical vehicle trip data in real-time includes recording vehicle trip data and creating a record of historical vehicle trip data, the record of historical vehicle trip data including vehicle trip data from at least one previously conducted vehicle trip, and during the current vehicle trip, evaluating the current vehicle trip. Evaluating the vehicle trip includes recording vehicle data during the current vehicle trip, accessing the record of historical vehicle trip data, and comparing the vehicle trip data of the current vehicle trip to the historical vehicle trip data in real time during the current vehicle trip.

Accordingly, the present system and method provides a real-time trip comparison to a user's own saved trips, instead of comparing the current trip information to a fixed standard. This allows the user to compare a current vehicle trip to a trip the user has driven in the past, which tracks progress from one trip to the next. Additionally, the user may compare trip data during the current trip in real-time. The real-time comparison allows the customer to conduct three types of evaluations: (1) to compare trips on the same route (comparison based on distance) to determine how the duration and average consumption differ, (2) to compare trips of different routes (comparison based on time) and determine how their distance and average consumption differ, and (3) to compare their driving behavior on different trips (comparison based on cumulative consumption) and see how their distance and duration differ.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, do not limit the present invention, and wherein:

FIG. 1 illustrates a system 100 according to certain exemplary embodiments of the present invention;

FIG. 2 illustrates a vehicle interior incorporating the system 100 illustrated in FIG. 1;

FIG. 3 illustrates a method 300 according to certain exemplary embodiments of the present invention;

FIG. 4 illustrates a content display 400 according to an exemplary embodiment of the present invention;

FIG. 5 illustrates a content display 400 according to an exemplary embodiment of the present invention;

FIG. 6 illustrates a content display 400 according to an exemplary embodiment of the present invention;

FIGS. 7A-7C illustrate a content display browsing procedure;

FIG. 8 illustrates a content display 400 according to an exemplary embodiment of the present invention;

FIG. 9 illustrates a content display 400 according to an exemplary embodiment of the present invention;

FIG. 10 illustrates a content display 400 according to an exemplary embodiment of the present invention; and

FIG. 11 illustrates a content display 400 according to an exemplary embodiment of the present invention.

### DETAILED DESCRIPTION

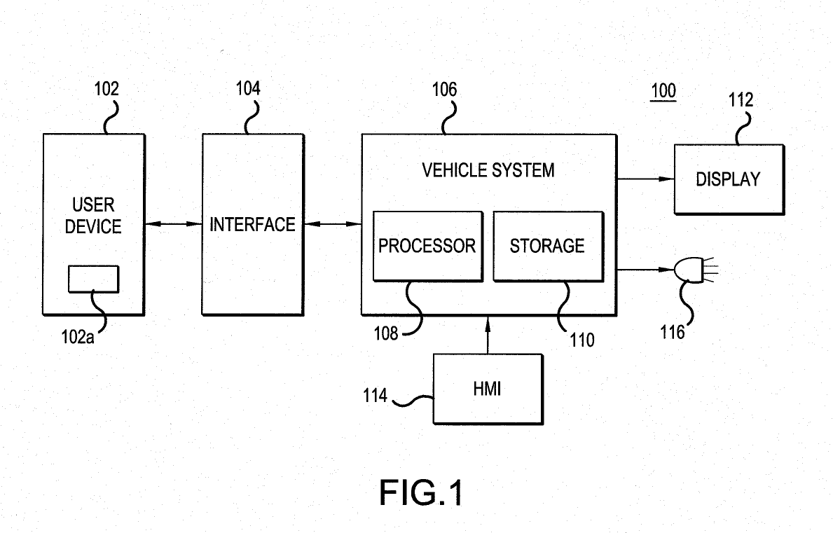

Referring now to the drawings, and more particularly to FIGS. 1-3, there are shown exemplary embodiments of the method and structures according to the present invention.

FIG. 1 illustrates a system 100 according to certain exemplary embodiments of the present invention. The system 100 includes a user device 102 (e.g., mobile device, mobile telephone, smartphone, laptop, etc.) configured to connect to a vehicle system 106. The mobile device 102 includes a vehicle trip information program 102a (e.g., smartphone application) stored on the mobile device 102 and programmed and configured to interact with the vehicle system 106. The mobile device 102 is configured to connect to and interact with the vehicle system 106 through an interface 104. According to certain exemplary embodiments, the interface 104 may include a physical connection (e.g., in-vehicle docking station). Alternatively, the interface 104 may include a wireless connection (e.g., internet, Bluetooth, etc.).

The mobile device 102 is configured to transmit data to and receive data from the vehicle system 106 through the interface 104. The vehicle system 106 includes a processor 108 configured to receive and process data received from the mobile device 102 and input by the user directly into the vehicle system 106. The vehicle system 106 also includes a storage device 110 configured to store data received from the mobile device 102 and input by the user directly into the vehicle system 106. Additionally, the vehicle system 106 records and stores vehicle data while the vehicle is operated. The vehicle system 106 may be embedded within the overall vehicle operating system, embedded within the vehicle navigation system or as a designated system for recording and processing vehicle trip information. Alternatively, the vehicle system 106 may be positioned remotely and may be configured to interact wirelessly with the user device 102 and the vehicle.

The system 100 also includes a display 112. The display 112 may include a touch screen or a non-touch-enable screen. The display screen 112 may be installed in the vehicle console or may be incorporated into a heads-up display. Additionally, the display screen 112 may include a designated system screen or may be incorporated into the vehicle infotainment/navigation system. The system 100 also includes a human machine interface 114 (e.g., controls installed in a vehicle console, touch screen inputs, controls installed on a vehicle steering wheel, voice-activated controls, etc.), through which a user (e.g., vehicle driver, vehicle passenger, etc.) may interact with the vehicle system 106 and user device 102. The user may input data into the system or control information displayed on the display screen 112. Additionally, through the human machine interface 114, the user may manipulate information transferred to, received from, and/or displayed on the user device 112. Furthermore, the system 100 includes speakers 116 configured to issue auditory responses to user input and/or system processing of data.

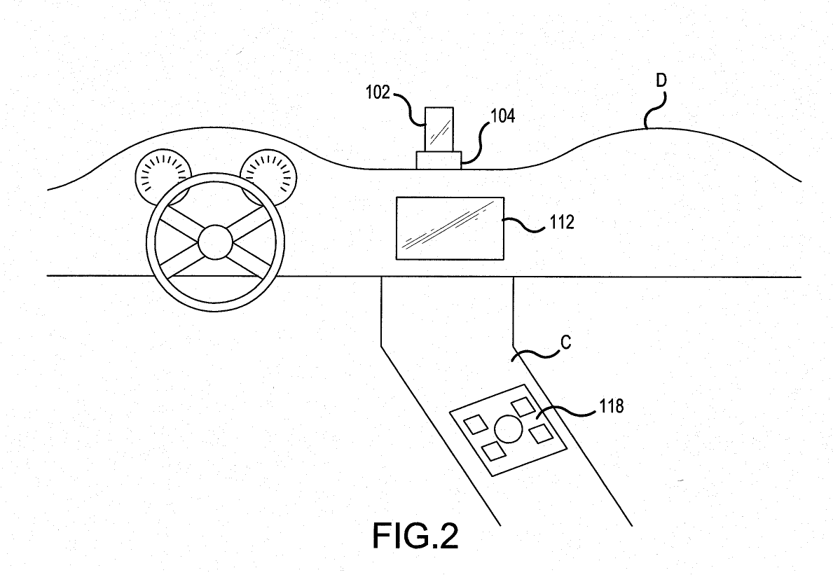

FIG. 2 illustrates a specific example of the system illustrated in FIG. 1. FIG. 2 illustrates a vehicle interior including a console C and a dashboard D. In the embodiment illustrated in FIG. 2, the user device 102 is connected to the vehicle system through the interface 104. As illustrated in FIG. 2, the interface 104 includes a physical docking station. The display 112 includes a screen installed in the vehicle dashboard D. In the embodiment illustrated in FIG. 2, the human machine interface includes a control device 118 embedded within the console C.

The storage device 110 in the vehicle system 106 is configured to store vehicle trip information (e.g., distance travelled, trip duration, average fuel/energy consumption, etc.). The vehicle trip information for each trip is recorded and stored in a historical vehicle trip information database. When the user device 102 is connected to the vehicle system 106, the user device 102 receives the vehicle trip information from the vehicle system 106. Accordingly, a record of the user's trip is created and saved on the user device 102. Additionally, during a current vehicle trip, the user device 102 receives vehicle trip information related to the current vehicle trip in real-time (e.g., once every second). Accordingly, the system 100 allows the user to compare current (and future) trips in real-time to the saved vehicle trip information. Specifically, the vehicle trip information program 102a on the user device 102 is configured to receive and process the vehicle trip information to provide a comparison of a current vehicle trip to the saved vehicle trip information in real-time. The comparison information is presented such that the user is able to easily understand the information and how the current trip compares to the saved trip information. For example, the presented information can identify whether the current distance is longer or shorter than previous trips, whether the current trip duration is longer or shorter than previous trips, and/or whether the current fuel consumption (average or total) is higher or lower than previous trips, etc. Furthermore, the current trip may be compared to a single previous vehicle trip, multiple vehicle trips, or an average of some or all of the stored vehicle trips.

The comparison may then be presented to the user on the user device 102. Alternatively, the comparison may be transmitted from the user device 102 to the vehicle 106 and presented to the user on the in-vehicle display 112. Whether presented on the user device 102 or the in-vehicle display 112, the comparison information may be presented in text format or image format. Additionally, the presentation of the comparison information may be include auditory information (e.g., through the speakers of the vehicle infotainment system). Additionally, whether presented on the user device 102 or the display 112, the user may interact with the presented information either using the in-vehicle human machine interface 114 or the controls on the user device 102.

The system 100 is configured to allow a user to compare a current trip to one or more trips that the user has driven in the past, allowing the user to track progress from one trip to the next. According to certain exemplary embodiments of the invention, the system 100 allows the user to conduct three types of evaluations in real-time: (1) to compare trips on the same route (comparison based on distance) to see how their duration and average fuel consumption differ; (2) to compare trips of different routes (comparison based on time) and see how their distance and average fuel consumption differ; and (3) to compare their driving behavior on different trips (comparison based on consumption) and see how their distance and duration differ.

In order to perform the comparison, the system 100 uses trip information data (e.g., distance, duration, consumption, etc.) that is transmitted from the vehicle to the user device 102 every second. Accordingly, the system 100 is able to display the current trip data at an update rate of once per second. As updating the displayed information every second may become distracting, the system 100 is configured such that the user may set an update interval (e.g., every 10 seconds, every minute, etc.).

As indicated above, the system 100 is configured to perform three types of comparisons. It is noted that the three types of comparisons listed above and discussed further below are merely exemplary, non-limiting applications of the present invention. Additionally, it is noted that the comparison may be performed on the user device 102 (e.g., using the vehicle information program/application 102a) or on the vehicle system 106. That is, while the embodiment illustrated in FIG. 1 includes a user device 102, the entire comparison may be performed entirely using an in-vehicle system.

With respect to the comparison based on distance, the system obtains the duration and consumption values of a saved trip(s), from the vehicle trip information record, at a distance mark that matches the distance mark of the current trip. For example, the current trip information is 3 km, 2 minutes, 5.1 l/100 km and the saved trip information is 3 km, 4 minutes, 5.8 l/100 km (it is noted that the fuel consumption may be provided as an average or as a total amount used over the course of the entire trip).

With respect to the comparison based on time, the system obtains the distance and consumption values of the saved trip at a timestamp that matches that of the current trip. For example, the current trip information is 3 km, 2 minutes, 5.1 l/100 km and the saved trip information is 1.5 km, 2 minutes, and 5.8 l/100 km.

With respect to the comparison based on consumption, the system obtains the distance and duration values of the saved trip at the consumption level that matches that of the current trip. For example, the current trip information is 3 km, 2 minutes, and 5.1 l/100 km and the saved trip information is 1.5 km, 1 minute, and 5.1 l/100 km.

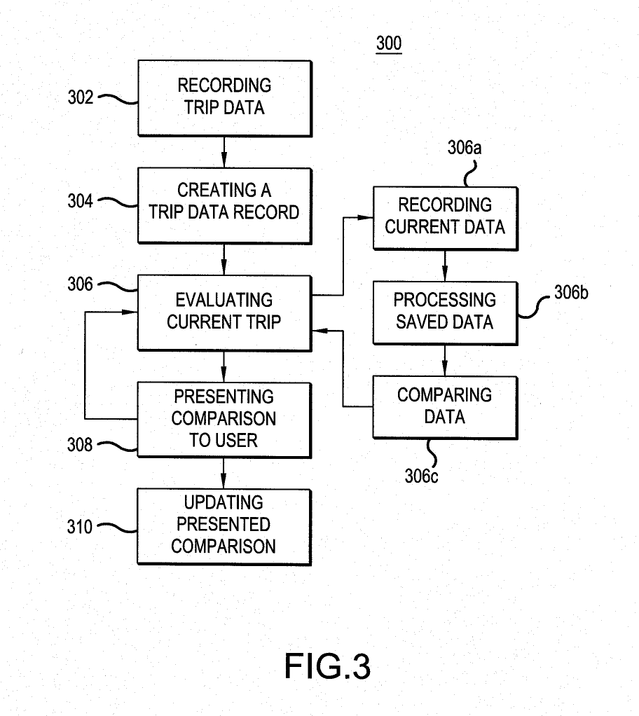

FIG. 3 illustrates a method 300 according to certain exemplary embodiments of the present invention. The method 300 includes recording vehicle trip data 302 and creating a record of historical vehicle trip data 304. The record of historical vehicle trip data includes, as detailed above, vehicle trip data from at least one previously conducted vehicle trip. Then, the method includes, during the current vehicle trip, evaluating the vehicle trip 306. The evaluation includes recording vehicle data during the current vehicle trip 306a, accessing the record of historical vehicle trip data 306b, and comparing the vehicle trip data of the current vehicle trip to the historical vehicle trip data in real time during the current vehicle trip 306. The results of the comparison are then presented to the user 308. As the current trip information is continued to be recorded in real-time, the evaluation of the current trip data 306 is repeated and the information presented to the user is updated in real-time 310.

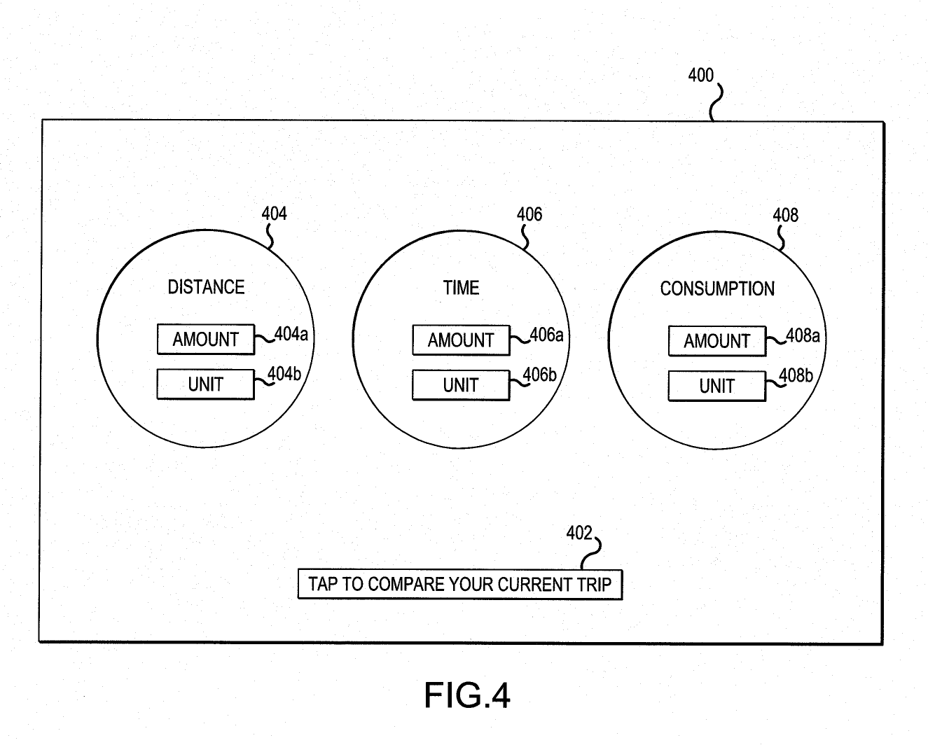

FIGS. 4-11 illustrate exemplary embodiments of the present invention. Specifically, FIGS. 4-11 illustrate examples of graphical images displayed by the present system/method. The graphics may be displayed on a display screen of the user device 102 and/or an in-vehicle display 112.

FIG. 4 illustrates an exemplary content display 400 according to certain exemplary embodiments of the present invention. The content display 400 illustrated in FIG. 4 illustrates an initial/default view of the content display 400 when the user device 102 is initially docked. The system may be configured such that the default screen automatically initiates when the user device 102 is docked.

The content display 400 includes a plurality of inner display graphics. In the exemplary embodiment illustrated in FIG. 4, the content display 400 includes three inner display graphics, including a distance graphic 404, a time graphic 406 and a consumption graphic 408. In an initial operation of the display 400, the distance graphic 404 indicates the current distance traveled. During a current trip, the distance graphic 404 indicates the current amount of distance 404a traveled and the corresponding distance unit 404b (e.g., miles, km, etc.). The time graphic 406 indicates the time elapsed during the current trip. During the current trip, the time graphic indicates the current amount of time elapsed 406a and the corresponding time unit 406b (e.g., hours, minutes, seconds, etc.). The consumption graphic 408 indicates the amount of fuel/energy consumed during the current trip. During the current trip, the consumption graphic indicates the current amount of fuel/energy consumed 406a and the corresponding fuel/energy unit 406b (e.g., liters, gallons, etc.). The consumption graphic 408 may be configured to display a total amount of fuel/energy consumed (e.g., gallons of fuel) during the trip or an average consumption during the trip (e.g., miles per gallon). The system may be configured to automatically update the current trip's distance, duration and consumption at a specified time interval (e.g., update every 10 seconds) or continuously.

The content display 400 also includes an interactive region (e.g., configured to receive user touch input) 402. The user may interact (e.g., user touch/tap input) with the interactive region 402 to instruct the system to compare the current trip to data of a saved trip.

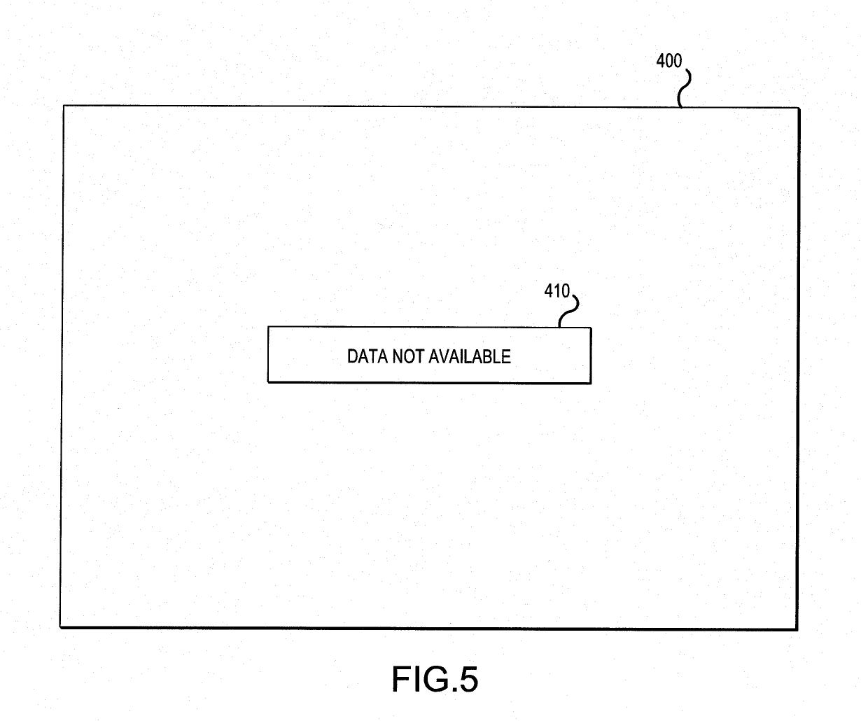

Once the user inputs a command to compare the current trip to a saved trip, the system searches for saved trip data. If no trip data is available, the content display 400 is configured to display a message as exemplarily illustrated in FIG. 5. Specifically, the content display 400 displays a message 410 indicating “Data Not Available,” or another similar message.

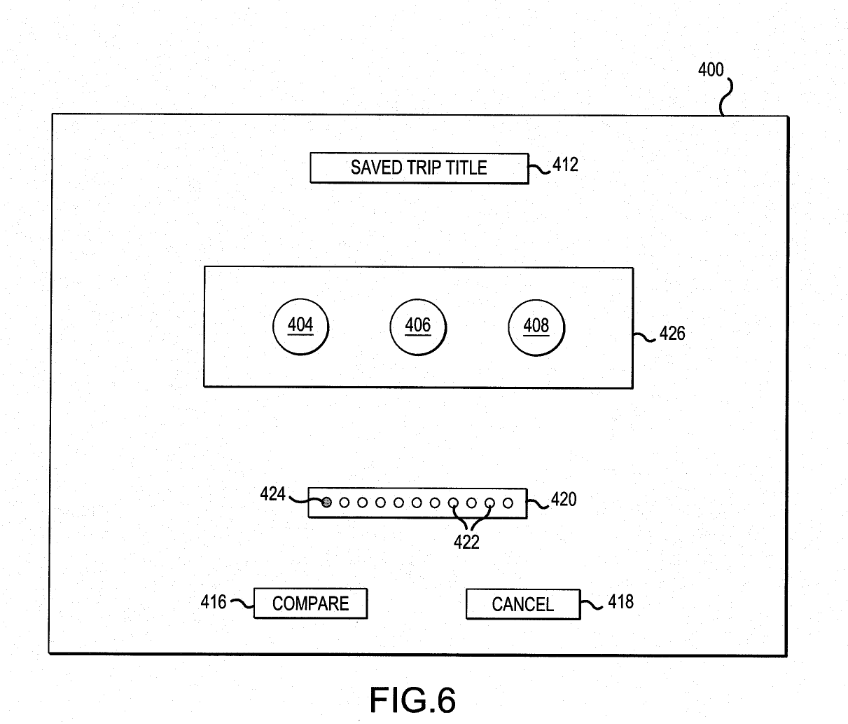

If saved trip data is available, the system is configured to display a comparison selection screen on the content display 400, as illustrated in FIG. 6. In the comparison selection screen, the content display 400 displays information for a saved trip and is configured to allow a user to select a trip from one or more saved trips for comparison. The saved trips may include a list of the most recent trips or may include a list of trips identified as “favorites” by the user. The content display 400 initially displays a first one of the one or more corresponding saved trips. The displayed saved trip is identified by a title of the saved trip displayed in a title region 412. The user may input a specific title of the trip when saving the trip data. During future comparisons, the saved trip will be identified by the trip title, which will be displayed in the title region 412.

The content display 400 also includes a saved trip indicator 420 that is configured to indicated the number of available trips. The system may be configured to set a maximum number of trips (e.g., 10) available. Each available saved trip is indicated by an indicator 422. In the embodiment illustrated in FIG. 6, each indicator includes a dot, however, any suitable icon may be used. The indicator corresponding to the saved trip being currently displayed is shaded, colored, highlighted, etc. 424. The saved trip indictor 420 is configured to allow a user to interact and input selections. For example, the user may swipe across the saved trip indicator (or, alternatively, across the content display) to scroll through each of the available saved trips.

The content display 400 is also configured to include an interactive comparison selection input 416. Once the user identifies a saved trip for comparison, the user may select that trip by interacting (e.g., touch/tap input) with the selection input 416. Additionally, the content display 400 includes an interactive cancel input 418. The user is able to interact (e.g., touch/tap input) with the cancel input 418 to cancel the trip comparison and return to the default content display screen.

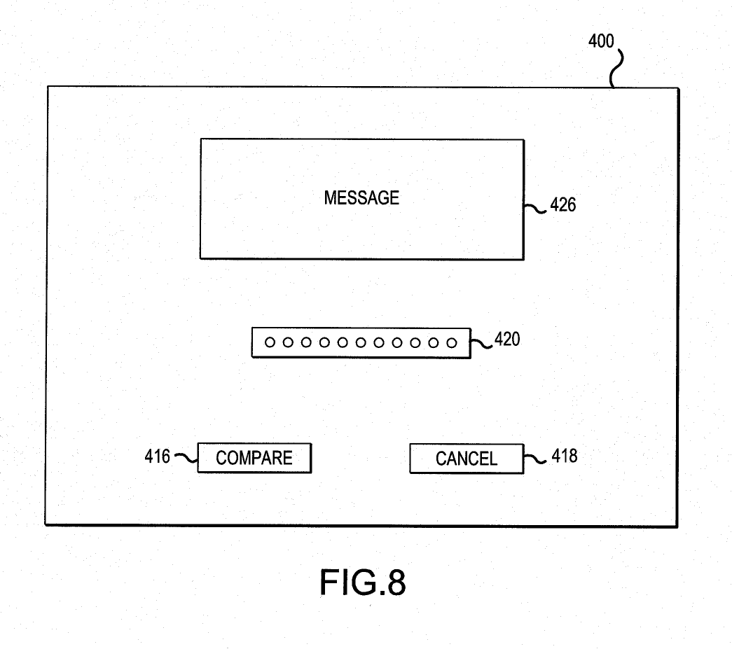

The content display 400 also includes a saved trip information region 426. The saved trip information region includes a distance graphic 404, a time graphic 406 and a consumption graphic 408 for the currently highlighted/displayed saved trip. Alternatively, the saved trip information region 426 may display a message to the user, as is illustrated in FIG. 8. For example, if no saved trip data is available, the system is configured to display a message reading, for example: “No trip data is available. New trips are automatically stored when driving and your user device is docked,” or “You can select more favorite trips in setup when you undock your user device.”

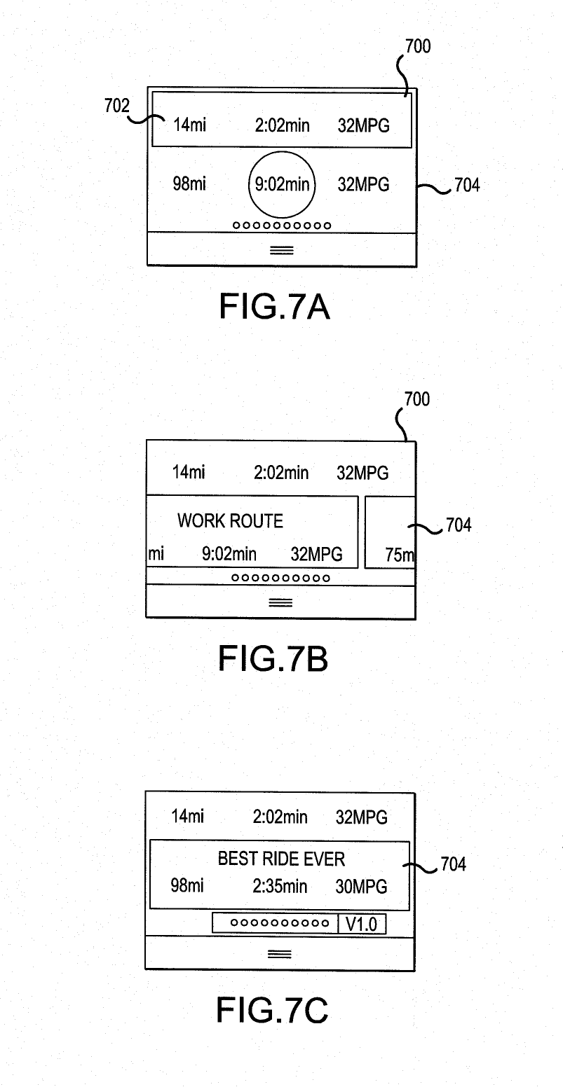

FIGS. 7A-7C further illustrate an alternative browsing mode for selecting a specific one of the plurality of saved trips. FIG. 7A illustrates an initial screen 700 displayed on the content display 400. The initial screen 700 includes a current trip region 702 and a saved trip preview region 704. The saved trip preview region may display the distance, duration and consumption data for the saved trip and may also indicate the title, if provided, for the saved trip. FIG. 7B illustrates the screen as the user is browsing through the saved trips. As is illustrated in FIG. 7B, the user may, through a swiping touch motion, change the saved trip information displayed in the saved trip preview region 704. Once the user identifies a specific trip, as in FIG. 7C, the user may select the specific trip by tapping or pressing the saved trip preview region.

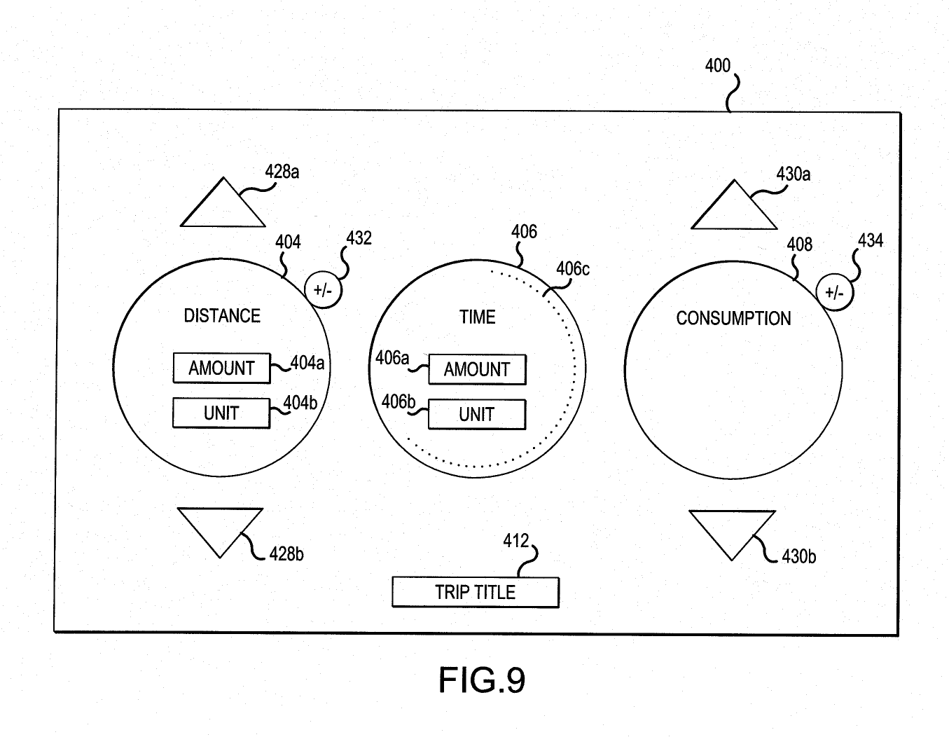

Once the user selects a specific saved trip, the system is configured to display a trip comparison screen on the content display 400, as is exemplarily illustrated in FIG. 9. Similar to the initial default screen, the content display 400 also includes a plurality of inner display graphics including the distance graphic 404, the time graphic 406 and the consumption graphic 408. The distance graphic 404, the time graphic 406 and the consumption graphic 408 display the distance, time and consumption data for the current trip. The content display also includes a title region 412 indicating the title of the saved trip being compared to the current trip.

The comparison screen also includes indicators for each of the distance graphic 404, the time graphic 406 and the consumption graphic 408 to graphically and/or numerically indicate a difference between the time, distance and/or consumption values for current and saved trips. For example, the distance graphic 404 includes a first arrow 428a above the distance graphic 404 and a second arrow 428b below the distance graphic. The arrows 428a/428b indicate a positive or negative delta value between the current trip and the saved trip. For example, if the distance of the current trip has exceed that of the saved trip, the top arrow 428a is highlighted indicating a positive delta value. If the distance of the current trip is less than that of the saved trip, the bottom arrow 428b is highlighted indicating a negative delta value. Additionally, the arrows 428a/428b may display a “+” or “−” sign and/or a numerical value further indicating the difference in distance between the saved and current trips. Furthermore, the distance graphic includes a separate numerical indicator 432 indicating the numerical delta value with a “+” or “−” sign.

The consumption graphic 408 includes a first arrow 430a above the distance graphic 408 and a second arrow 430b below the consumption graphic. The arrows 430a/430b indicate a positive or negative delta value between the current trip and the saved trip. For example, if the consumption of the current trip has exceed that of the saved trip, the top arrow 430a is highlighted indicating a positive delta value. If the consumption of the current trip is less than that of the save trip, then bottom arrow 430b is highlighted indicating a negative delta value. Additionally, the arrows 430a/430b may display a “+” or “−” sign and/or a numerical value further indicating the difference in consumption between the saved and current trips. Furthermore, the consumption graphic includes a separate numerical indicator 434 indicating the numerical delta value with a “+” or “−” sign.

The time graphic 406 is configured to include an inner circle 406c, which indicates what portion of the saved trip time has been completed. That is, as the current trip progresses, the inner circle graphic 406c fills up (e.g., clockwise) from an empty circle to a full circle. The inner circle graphic 406c should be complete when the duration of the current trip is equal to that of the saved trip.

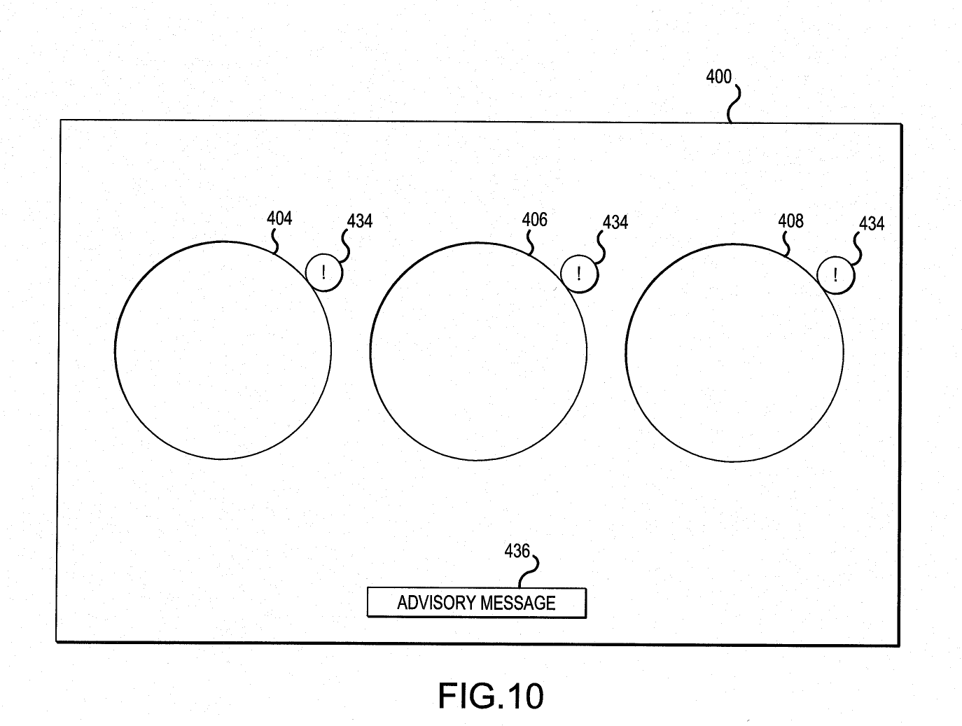

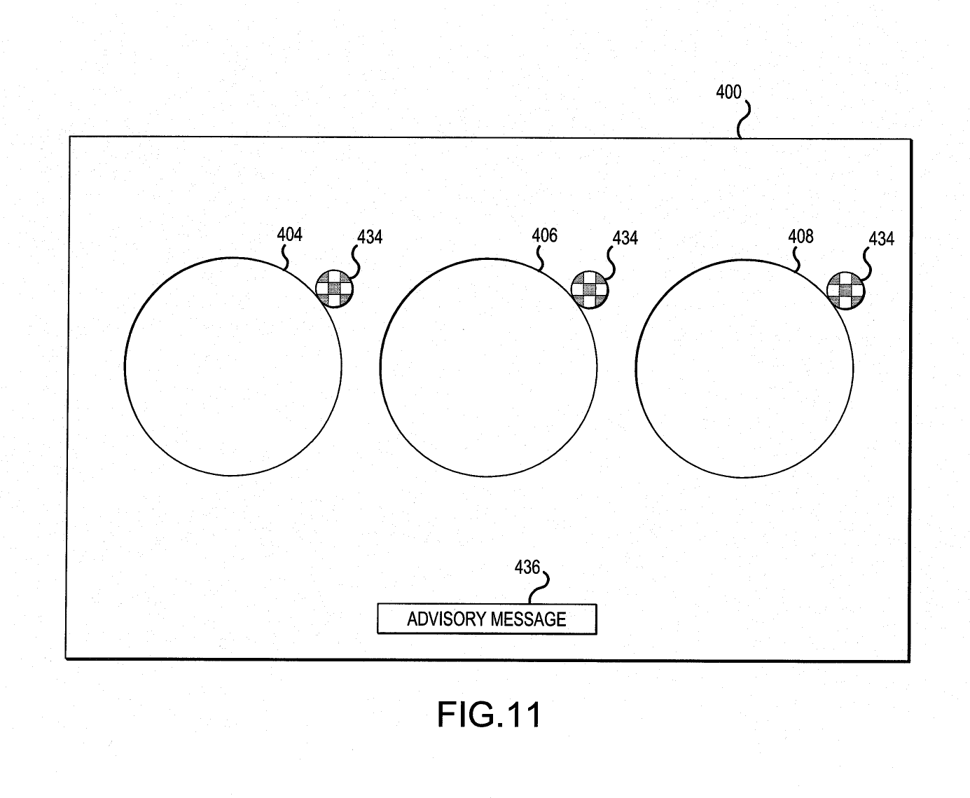

The content display may also graphically display saved trip advisories. For example, as is illustrated in FIGS. 10 and 11, the distance graphic 404, the time graphic 406 and/or the consumption graphic 408 may include an advisory indicator 434. In FIG. 10, the advisory indicator displays an icon (e.g., in the exemplary embodiment an “!” is used, however, any suitable icon may be used) indicating that the saved trip data has holes (i.e., portions of missing data). Alternatively, in FIG. 11, the advisory indicator 434 displays an icon (e.g., in the exemplary embodiment a finish-line symbol/flag is used, however, any suitable icon may be used) indicating that the data for the saved trip has been exceeded. The individual advisory indicators are displayed individually based on whether the distance, time and/or consumption have been exceeded and/or have missing data.

Alternatively, the saved trip advisory may include an advisory message region 436. The advisory message region 436 may alphanumerically display a message indicating the specific advisory. For example, the advisory message region 436 may display a message indicating: “Data hole in saved trip” or “Saved trip data exceed,” for example.

The method 300 and system 100 of the invention, described above, may be implemented in a typical computer hardware configuration, which may be incorporated into the vehicle (or may be incorporated into the existing vehicle navigation system and/or overall vehicle computer system). Additionally, a different aspect of the invention includes a computer-implemented method for performing at least certain steps in the above method. Such a method may be implemented, for example, by operating a computer, as embodied by a digital data processing apparatus, to execute a sequence of machine-readable instructions. These instructions may reside in various types of storage media. Thus, this aspect of the present invention is directed to a programmed product, including storage media (or a storage device) tangibly embodying a program of machine-readable instructions executable by a digital data processor to perform the above method.

This storage media may include, for example, a RAM contained within the CPU, as represented by the fast-access storage for example. Alternatively, the instructions may be contained in another storage media, such as a magnetic data storage diskette, compact disc, or other removable storage media/device, directly or indirectly accessible by the CPU.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method comprising:
accessing a record of a previous conducted vehicle trip, the record comprising vehicle trip information for the previous conducted vehicle trip;
recording vehicle information for a current vehicle trip; and
comparing the vehicle information for the current vehicle trip to the vehicle trip information for the previous conducted vehicle trip.

2. The method according to claim 1, wherein the vehicle trip information comprises duration, distance, or fuel consumption.

3. The method according to claim 1, wherein the vehicle trip information comprises duration, distance and fuel consumption.

4. The method according to claim 1, further comprising providing results of said comparing to a user during the current vehicle trip.

5. The method according to claim 4, further comprising updating said results in real-time during the current vehicle trip.

6. The method according to claim 1, wherein said comparing comprises a comparison based on distance traveled, a comparison based on trip duration, or a comparison based on fuel consumption.

7. The method according to claim 1, wherein said comparing comprises comparing a trip duration value and a fuel consumption value of the current vehicle trip at a distance mark to a trip duration value and a fuel consumption value for the previous conducted trip at a distance mark that matches the distance mark of the current vehicle trip.

8. The method according to claim 1, wherein said comparing comprises comparing a distance value and a fuel consumption value of the current vehicle trip at a timestamp to a trip duration value and a fuel consumption value for the previous conducted trip at a timestamp that matches the timestamp of the current vehicle trip.

9. The method according to claim 1, wherein said comparing comprises comparing a trip duration value and a distance value of the current vehicle trip at a fuel consumption level to a trip duration value and a distance value for the previous conducted trip at a fuel consumption level that matches the fuel consumption level of the current vehicle trip.

10. The method according to claim 1, wherein said comparing comprises:
comparing a trip duration value and a fuel consumption value of the current vehicle trip at a distance mark to a trip duration value and a fuel consumption value for the previous conducted trip at a distance mark that matches the distance mark of the current vehicle trip;
comparing a distance value and a fuel consumption value of the current vehicle trip at a timestamp to a trip duration value and a fuel consumption value for the previous conducted trip at a timestamp that matches the timestamp of the current vehicle trip; or
comparing a trip duration value and a distance value of the current vehicle trip at a fuel consumption level to a trip duration value and a distance value for the previous conducted trip at a fuel consumption level that matches the fuel consumption level of the current vehicle trip.

11. A system, comprising:
a database containing a record of a previous conducted vehicle trip, the record comprising vehicle trip information for the previous conducted vehicle trip;
a record device configured to record vehicle information for a current vehicle trip; and
a component configured to compare the vehicle information for the current vehicle trip to the vehicle trip information for the previous conducted vehicle trip.

12. The system according to claim 11, further comprising a user device configured to receive the vehicle trip information in real-time.

13. The system according to claim 12, wherein the vehicle trip information is transmitted to the user device once per second.

14. The system according to claim 12, wherein the user device comprises a smartphone.

15. A method for comparing vehicle trip data of a current vehicle trip to historical vehicle trip data in real time, the method comprising:
recording vehicle trip data and creating a record of historical vehicle trip data, the record of historical vehicle trip data comprising vehicle trip data from at least one previously conducted vehicle trip; and
during the current vehicle trip, evaluating the current vehicle trip, said evaluating the vehicle trip comprising:
recording vehicle data during the current vehicle trip;
accessing the record of historical vehicle trip data; and
comparing the vehicle trip data of the current vehicle trip to the historical vehicle trip data in real time during the current vehicle trip.

16. The method according to claim 1, wherein said comparing comprises:
comparing a trip duration value and a fuel consumption value of the current vehicle trip at a distance mark to a trip duration value and a fuel consumption value for the previous conducted trip at a distance mark that matches the distance mark of the current vehicle trip;
comparing a distance value and a fuel consumption value of the current vehicle trip at a timestamp to a trip duration value and a fuel consumption value for the previous conducted trip at a timestamp that matches the timestamp of the current vehicle trip; or
comparing a trip duration value and a distance value of the current vehicle trip at a fuel consumption level to a trip duration value and a distance value for the previous conducted trip at a fuel consumption level that matches the fuel consumption level of the current vehicle trip.

17. The method according to claim 15, further comprising providing a result of said comparing to a user in real-time.
